(19) United States
(12) Patent Application Publication
(10) Pub. No.: US 2015/0185588 A1
(43) Pub. Date: Jul. 2, 2015

(54) STROBE DEVICE AND IMAGE PICK-UP DEVICE PROVIDED WITH STROBE DEVICE

(71) Applicant: Panasonic Intellectual Property Management Co., Ltd., Osaka (JP)

(72) Inventors: Yusuke Saita, Wakayama (JP); Kazuhiko Ooyama, Hyogo (JP)

(73) Assignee: Panasonic Intellectual Property Management Co., Lt, Osaka (JP)

(21) Appl. No.: 14/418,474

(22) PCT Filed: Aug. 19, 2013
(86) PCT No.: PCT/JP2013/004886

§ 371 Date: Jan. 30, 2015

(30) Foreign Application Priority Data
Aug. 20, 2012 (JP) 2012-181481

(51) Int. Cl. G03B 15/05; F21V 14/02

(52) U.S. Cl. CPC G03B 15/05; F21V 14/025

(57) ABSTRACT

The present invention provides a strobe device which includes: a light-emitting unit rotatably coupled to a strobe body unit which is detachably mounted on an imaging apparatus; a variable mechanism capable of varying an angle of orientation of the light-emitting unit with respect to the strobe body unit; a driving unit for driving the variable mechanism; a control section for controlling the driving unit; and a detection unit. The detection unit detects that the strobe body unit is detached from the imaging apparatus, and the control section has a mode of varying the angle of orientation of the light-emitting unit to a predetermined detached-state angle of orientation based on a detection result by the detection unit. With such a configuration, it is possible to realize the strobe device which can obviate an unnecessary operation by a user.

### TECHNICAL FIELD

The present invention relates to a strobe device of an emission direction angle variable type capable of varying an angle of orientation of a light-emitting unit, and an imaging apparatus provided with the strobe device.

### BACKGROUND ART

Conventionally, in an imaging apparatus, to acquire a more natural image, there has been adopted bounce photography where strobe light emitted from a light-emitting unit of a strobe device is directed to and diffused by a reflective object such as a ceiling or a wall, and a subject to be imaged is captured by indirectly illuminating the subject to be imaged.

That is, in bounce photography, a light emitting surface of the light-emitting unit of the strobe device does not face the subject to be imaged in an opposed manner, and the light emitting surface is directed in a desired direction toward a reflective object such as a ceiling or a wall, strobe light is reflected on the reflective object, and the subject to be imaged is captured by being illuminated by reflected strobe light.

With respect to the conventional strobe device, there has been proposed a configuration in which a bounce angle formed by a capturing direction which is an optical axis direction of a capturing lens and an emitting direction where strobe light is emitted (a desired direction toward the reflective object) is automatically controlled by a control section of the strobe device (see PTL 1, for example). With such a configuration, a light-emitting unit of the strobe device always emits strobe light in the direction toward the reflective object so that a subject to be imaged can be indirectly illuminated.

Further, in the strobe device described in PTL 1, the automatic focusing distance measurement is performed by directing imaging lenses of the imaging apparatus to a top surface (above reflective object) such as a ceiling and to a subject to be imaged respectively, a bounce angle is set based on the distances with the reflective object and the subject to be imaged, and the subject to be imaged is captured.

Then, when the capturing is finished, usually, a user detaches the strobe device from the imaging apparatus. Thereafter, the user houses the imaging apparatus in a housing body such as a case, and houses the strobe device in a housing body such as a case respectively.

In this case, when an angle of orientation (angle of light emitting direction) of the light-emitting unit of the strobe device is held at a bounce angle at a point of time when capturing is finished, it is difficult to house the strobe device in the housing body. In view of the above, the user corrects the angle of orientation of the light-emitting unit of the strobe device and houses the strobe device in the housing body. To be more specific, the user corrects the angle of orientation of the light-emitting unit such that the form of the strobe device conforms to a shape of an inner space of the housing body, and houses the strobe device in the housing body.

On the other hand, when the user starts capturing, the user takes out the strobe device housed in the angle of orientation which conforms to the shape of the inner space of the housing body from the housing body, and mounts the strobe device on the imaging apparatus. At this stage, usually, the angle of orientation of the light-emitting unit when the strobe device is housed in the housing body and the angle of orientation of the light-emitting unit at the time of starting capturing differ from each other. Accordingly, at the time of starting capturing, it is necessary to correct the angle of orientation of the light-emitting unit of the strobe device to an orientation suitable for bounce photography. As a result, there exists a drawback that a user misses a perfect moment for the click of a shutter.

### CITATION LIST

### Patent Literature

PTL 1: Unexamined Japanese Patent Publication No. 2009-163179

### SUMMARY OF THE INVENTION

To overcome the above-mentioned drawbacks, a strobe device according to the present invention includes: a strobe body unit which is detachably mounted on an imaging apparatus; a light-emitting unit rotatably coupled to the strobe body unit; a variable mechanism capable of varying an angle of orientation of the light-emitting unit with respect to the strobe body unit; a driving unit for driving the variable mechanism; a control section for controlling the driving unit; and a detection unit. The detection unit detects that the strobe body unit is detached from the imaging apparatus, and the control section has a mode of varying the angle of orientation of the light-emitting unit to a predetermined detached-state angle of orientation based on a detection result by the detection unit.

According to such a configuration, the control section controls the driving unit, and the driving unit drives the variable mechanism thus varying the angle of orientation of the light-emitting unit with respect to the strobe body unit. Further, when the strobe body unit of the strobe device is detached from the imaging apparatus, the control section recognizes the removal of the strobe body unit by the detection unit. At this stage of operation, the control section controls the driving unit so as to bring the light-emitting unit of the strobe device into a predetermined detached-state angle of orientation. That is, when the strobe device is detached from the imaging apparatus, the angle of orientation of the light-emitting unit is automatically varied to the detached-state angle of orientation. Accordingly, the strobe device can be easily housed in a housing body in such a manner that the strobe device conforms to a shape of an inner space of the housing body. As a result, it is possible to realize the strobe device which has excellent operability by obviating an unnecessary operation by a user and prevents the occurrence of drawbacks at the time of housing the strobe device in the housing body.

Further, an imaging apparatus of the present invention includes the above-mentioned strobe device. Accordingly, it is possible to realize the imaging apparatus which has excellent operability and minimally generates drawbacks.

### BRIEF DESCRIPTION OF DRAWINGS

FIG. 1 is a block diagram showing a configuration of an imaging apparatus according to an exemplary embodiment of the present invention.

FIG. 2 is a side view of the strobe device according to the exemplary embodiment.

FIG. 3 is a top plan view of the strobe device according to the exemplary embodiment.

FIG. 4A is a view for illustrating a light emitting range in an up-and-down direction (vertical direction) which can be set by the strobe device according to the exemplary embodiment.

FIG. 4B is a view for illustrating a light emitting range in a left-and-right direction (horizontal direction) which can be set by the strobe device according to the exemplary embodiment.

FIG. 5A is a perspective view showing a state where the strobe device according to the exemplary embodiment is mounted on the imaging apparatus.

FIG. 5B is a perspective view showing a state where the strobe device according to the exemplary embodiment is detached from the imaging apparatus.

FIG. 5C is a perspective view showing a state where the strobe device according to the exemplary embodiment is again mounted on the imaging apparatus.

FIG. 5D is a perspective view showing a state after the strobe device according to the exemplary embodiment is mounted on the imaging apparatus.

### DESCRIPTION OF EMBODIMENT

Hereinafter, a strobe device and an imaging apparatus provided with the strobe device according to an exemplary embodiment of the present invention will be described with reference to the drawings. The exemplary embodiment described hereinafter is one example which embodies the present invention and does not intend to limit the technical scope of the present invention.

### Exemplary Embodiment

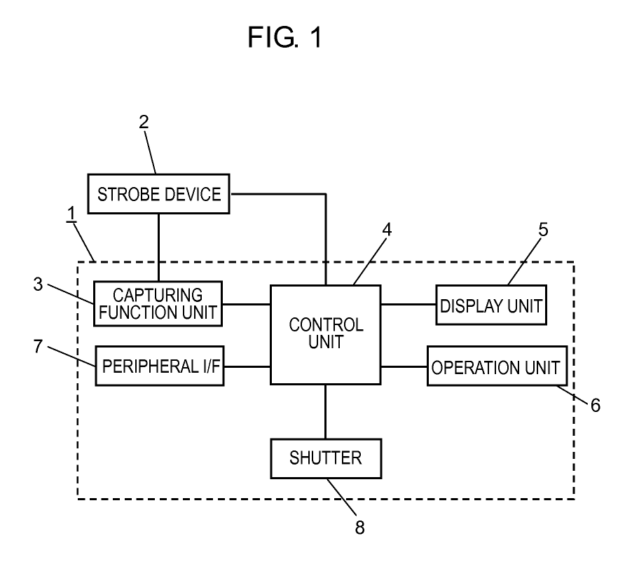

Hereinafter, the strobe device and the imaging apparatus provided with the strobe device according to the exemplary embodiment of the present invention will be described with reference to FIG. 1 to FIG. 4B.

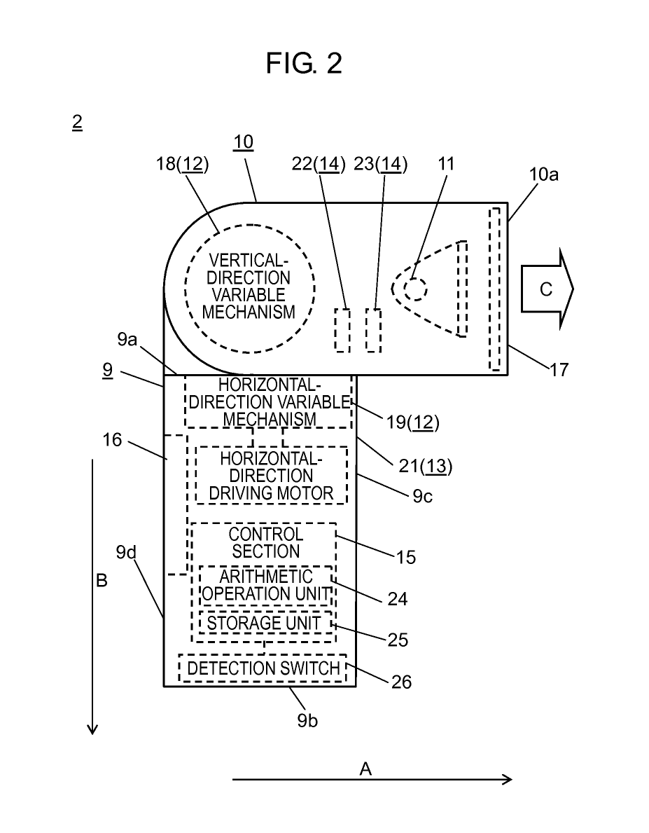

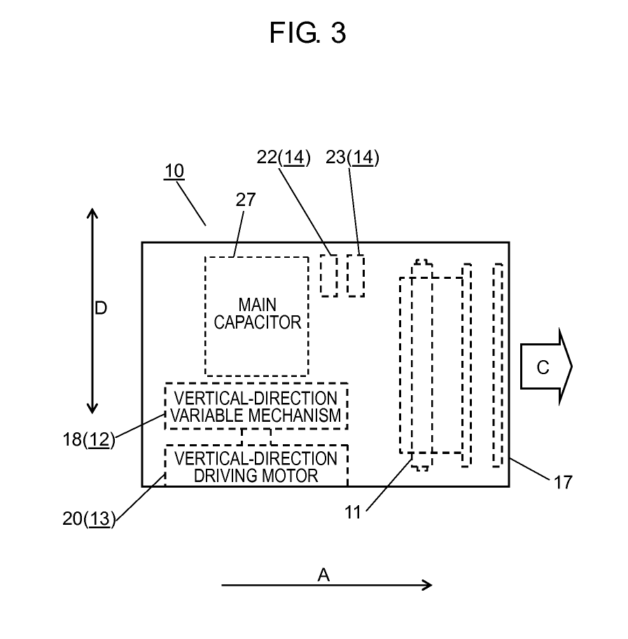

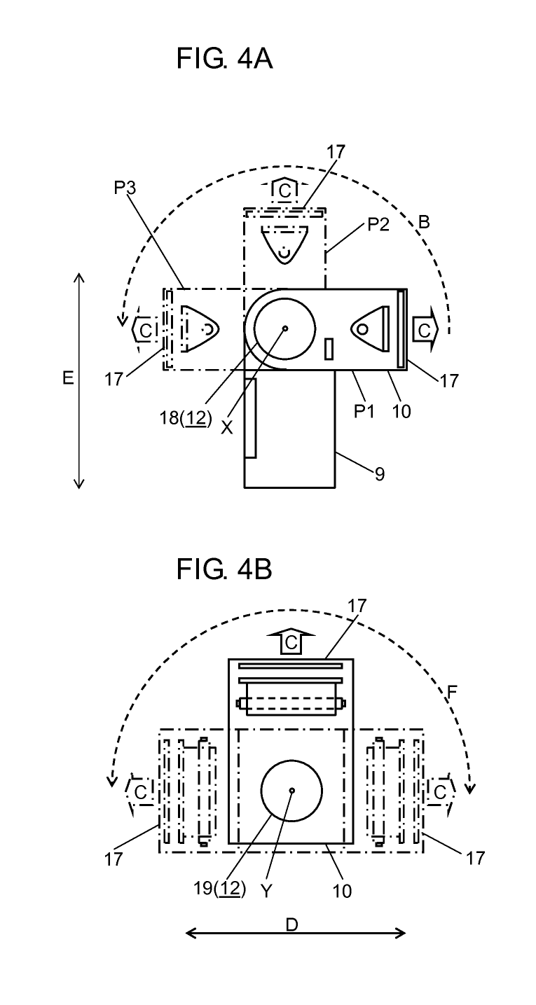

FIG. 1 is a block diagram showing the configuration of an imaging apparatus according to the exemplary embodiment of the present invention. FIG. 2 is a side view of the strobe device according to the exemplary embodiment. FIG. 3 is a top plan view of the strobe device according to the exemplary embodiment. FIG. 4A is a view for illustrating a light emitting range in an up-and-down direction (vertical direction) which can be set by the strobe device according to the exemplary embodiment. FIG. 4B is a view for illustrating a light emitting range in a left-and-right direction (horizontal direction) which can be set by the strobe device according to the exemplary embodiment.

As shown in FIG. 1, imaging apparatus 1 of the exemplary embodiment includes at least: capturing function unit 3 which captures a subject to be imaged; control unit 4, display unit 5; operation unit 6; peripheral I/F (interface) 7; shutter 8 or the like. Strobe device 2 which emits strobe light to a subject to be imaged can be mounted (in a detachable manner) on imaging apparatus 1. Control unit 4 controls strobe device 2 and capturing function unit 3. Display unit 5 displays an image formed by capturing a subject to be imaged or the like. Operation unit 6 changes over setting of a capturing condition and turning on or off of a power source. Peripheral I/F 7 inputs or outputs image data or the like between imaging apparatus 1 and a peripheral device. Shutter 8 is operated by a user for capturing a subject to be imaged while making strobe device 2 emit light.

As shown in FIG. 2 and FIG. 3, strobe device 2 of the exemplary embodiment includes at least: strobe body unit 9 formed of a rectangular shaped housing; light-emitting unit 10; variable mechanism 12; angle detection unit 14; control section 15; operating unit 16; and detection unit 26 which is configured of detection switch 26. Light-emitting unit 10 is rotatably coupled to strobe body unit 9, and flash discharge tube 11 is housed in light-emitting unit 10. In light-emitting unit 10, flash discharge tube 11 emits light due to electric energy supplied from main capacitor 27, for example, and emitted light is directed to the outside. Variable mechanism 12 can vary an angle of orientation of light-emitting unit 10. Driving unit 13 drives variable mechanism 12. Angle detection unit 14 detects an angle of light-emitting unit 10 with respect to strobe body unit 9. Control section 15 controls strobe device 2. Operating unit 16 is provided on a back side 9d of strobe body unit 9, for example, and performs inputting of various set values and the selection of various modes. Detection switch 26 is provided on a bottom side 9b of strobe body unit 9, and detects a mounting or detachable state of strobe device 2 with respect to imaging apparatus 1.

Light-emitting unit 10 is rotatably coupled to an top side 9a of strobe body unit 9. Further, imaging apparatus 1 shown in FIG. 1 is provided on a bottom side 9b of strobe body unit 9 in a couplable manner. In this case, strobe body unit 9 is coupled to imaging apparatus 1 such that front 9c of strobe body unit 9 is directed in capturing direction A of imaging apparatus 1 (an optical axis direction of an imaging lens).

Light-emitting unit 10 is formed of a housing formed into an approximately rectangular shape (including a rectangular shape), for example, and has opening portion 17 on one surface 10a side of the housing through which light emitted from flash discharge tube 11 is emitted. Light-emitting unit 10 is configured to vary emitting direction C along which strobe light is emitted by varying an inclination angle of orientation of opening portion 17 with respect to vertical direction B.

Further, as shown in FIG. 4A and FIG. 4B, variable mechanism 12 is configured of vertical-direction variable mechanism 18 and horizontal-direction variable mechanism 19, and variable mechanism 12 rotatably couples strobe body unit 9 and light-emitting unit 10 to each other. To be more specific, vertical-direction variable mechanism 18 of variable mechanism 12 is configured to rotatably couple strobe body unit 9 and light-emitting unit 10 to each other in vertical direction B about lateral axis X disposed along width direction D of strobe body unit 9 (see FIG. 3). On the other hand, horizontal-direction variable mechanism 19 of variable mechanism 12 is configured to rotatably couple strobe body unit 9 and light-emitting unit 10 to each other in horizontal direction F about longitudinal axis Y disposed in vertical direction E (height direction: see FIG. 4A) of strobe body unit 9.

Further, as shown in FIG. 4A, vertical-direction variable mechanism 18 of variable mechanism 12 is provided such that the angle of orientation of light-emitting unit 10 in vertical direction B is variable. To be more specific, vertical-direction variable mechanism 18 is configured to couple light-emitting unit 10 to the strobe body unit 9 such that an angle of orientation of light-emitting unit 10 in vertical direction B indicated by a solid line in FIG. 4A is rotatable within a range including a usual emitting direction angle (an angle at which light-emitting unit 10 is at usual capturing position P1) and a desired emitting direction angle which is set by a user as indicated by a chain line in FIG. 4A and is different from a usual light emitting direction angle (an angle at which light-emitting unit 10 is at bounce photography positions P2, P3). In the exemplary embodiment, vertical-direction variable mechanism 18 of variable mechanism 12 is rotatable within a rotational angle range of 180 degrees in the vertical direction, for example, between usual capturing position P1 and bounce photography position P3.

On the other hand, as shown in FIG. 4B, horizontal-direction variable mechanism 19 of variable mechanism 12 is provided on strobe body unit 9 such that the angle of orientation of light-emitting unit 10 is variable in horizontal direction F. Further, in the exemplary embodiment, horizontal-direction variable mechanism 19 has a rotational angle of 180 degrees in the lateral direction.

As shown in FIG. 2 and FIG. 3, driving unit 13 includes vertical-direction driving unit 20 (see FIG. 3) formed of a vertical-direction driving motor and the like, for example, which rotatably drives vertical-direction variable mechanism 18, and horizontal-direction driving unit 21 (see FIG. 2) formed of a horizontal-direction driving motor and the like, for example, which rotatably drives horizontal-direction variable mechanism 19.

Angle detection unit 14 is provided on light-emitting unit 10, and includes: vertical-direction angle detection unit 22 which detects an angle of light-emitting unit 10 in vertical direction B; and horizontal-direction angle detection unit 23 which detects an angle of light-emitting unit 10 in horizontal direction F.

In the exemplary embodiment, vertical-direction angle detection unit 22 is configured of a three-axis acceleration sensor which detects accelerations in three directions along XYZ axes, for example. By detecting gravitational accelerations in a static state by the three-axis acceleration sensor, an inclination angle of light-emitting unit 10 (an angle of orientation of light-emitting unit 10) in vertical direction B of light-emitting unit 10 is detected. In the exemplary embodiment, horizontal-direction angle detection unit 23 is configured of a magnetic field sensor which detects a strength and a direction of a magnetic field (or a field). By detecting a direction that light-emitting unit 10 is directed by the magnetic field sensor, an inclination angle of light-emitting unit 10 (an angle of orientation of light-emitting unit 10) in horizontal direction F of light-emitting unit 10 is detected.

Control section 15 includes arithmetic operation unit 24 which performs various arithmetic processing, and storage unit 25 which stores various information. Control section 15 is configured of a CPU, and storage unit 25 is configured of a RAM or a ROM incorporated into the CPU or a RAM or a ROM externally connected to the CPU. Storage unit 25 of control section 15 stores information relating to the detached-state angle of orientation described later and information relating to the mounted-state angle of orientation described later. Information relating to angle of orientation is information on angle of light-emitting unit 10 detected by vertical-direction angle detection unit 22 and horizontal-direction angle detection unit 23, for example.

Further, as described previously, control section 15 detects a mounted- or detached-state of strobe device 2 with respect to imaging apparatus 1 by detection unit 26 which is configured of detection switch 26 provided on a bottom side 9b of strobe body unit 9. To be more specific, detection switch 26 outputs an ON signal in a state where the bottom side 9b of strobe body unit 9 is provided on an top side of imaging apparatus 1, for example, in a state where the bottom side 9b of strobe body unit 9 is coupled to a hot shoe, and outputs an OFF signal when the coupling is released. Accordingly, control section 15 detects that strobe device 2 is detached from imaging apparatus 1 or that strobe device 2 is mounted on imaging apparatus 1.

Further, control section 15 includes a mode where the angle of orientation of light-emitting unit 10 is varied to a detached-state angle of orientation (hereinafter referred to as “a first mode”) and a mode for varying light-emitting unit 10 to a mounted-state angle of orientation (hereinafter referred to as “a second mode”). The first mode is a mode where when detection switch 26 detects that strobe device 2 is detached from imaging apparatus 1, that is, when light-emitting unit 10 is not at the detached-state angle of orientation, the angle of orientation of light-emitting unit 10 is varied to a predetermined detached-state angle of orientation. The second mode is a mode where when detection switch 26 detects that strobe device 2 is mounted on imaging apparatus 1, that is, when light-emitting unit 10 is not at the mounted-state angle of orientation, the angle of orientation of light-emitting unit 10 is varied to a predetermined mounted-state angle of orientation.

The above-mentioned predetermined detached-state angle of orientation is an angle of orientation of light-emitting unit 10 with respect to strobe body unit 9 for making strobe device 2 ready to be housed in a housing body such as a case (not shown in the drawing). On the other hand, the above-mentioned predetermined mounted-state angle of orientation is an angle of orientation of light-emitting unit 10 with respect to strobe body unit 9 when bounce photography starts, for example.

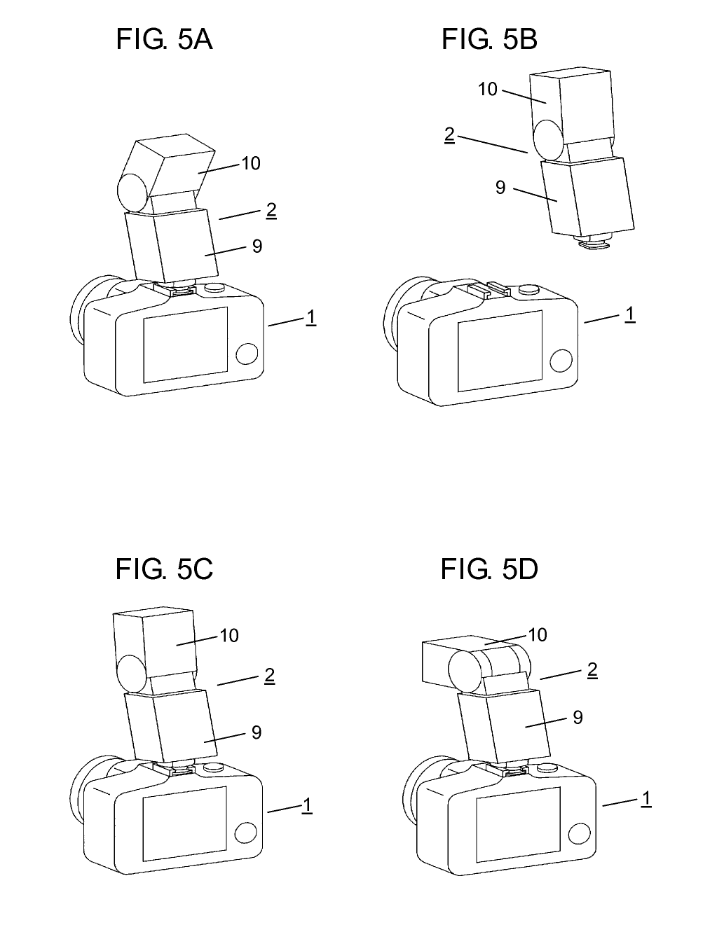

Hereinafter, the angle of orientation of light-emitting unit 10 of strobe device 2 according to the exemplary embodiment will be specifically described with reference to FIG. 5A to FIG. 5D.

FIG. 5A is a perspective view showing a state where the strobe device according to the exemplary embodiment is mounted on the imaging apparatus. FIG. 5B is a perspective view showing a state where the strobe device according to the exemplary embodiment is detached from the imaging apparatus. FIG. 5C is a perspective view showing a state where the strobe device according to the exemplary embodiment is again mounted on the imaging apparatus. FIG. 5D is a perspective view showing a state after the strobe device according to the exemplary embodiment is mounted on the imaging apparatus.

Firstly, the above-mentioned detached-state angle of orientation will be described with reference to FIG. 5A and FIG. 5B.

As shown in FIG. 5A, at the time of performing capturing such as bounce photography, a user performs capturing in a state where strobe device 2 in which strobe body unit 9 and light-emitting unit 10 are set at predetermined angles is mounted on imaging apparatus 1.

When the bounce photography is finished, the user detaches strobe device 2 from imaging apparatus 1 in a state where strobe body unit 9 and light-emitting unit 10 maintain predetermined angle of orientations in the bounce photography.

At this point of time, control section 15 of strobe device 2 detects that strobe device 2 is detached from imaging apparatus 1 by means of detection switch 26. Upon detection of removal of strobe device 2 from imaging apparatus 1, control section 15 drives vertical-direction driving unit 20 and/or horizontal-direction driving unit 21.

Then, as shown in FIG. 5B, an angle formed by strobe body unit 9 and light-emitting unit 10 is automatically varied such that strobe device 2 at the detached-state angle of orientation which is configured of the angle of orientation of light-emitting unit 10 in the vertical direction and/or the angle of orientation of light-emitting unit 10 in the horizontal direction is brought into a straightly extending state, for example. Accordingly, strobe device 2 can be housed in the housing body such as the case in a state where the shape of strobe device 2 conforms to the shape of an inner space of the housing body.

On the other hand, when the strobe device does not have a function of automatically correcting the detached-state angle of orientation as in the case of a conventional strobe device, it is necessary for a user to house strobe device 2 into the housing body by holding and rotating light-emitting unit 10 and by performing an operation of bringing strobe device 2 into a straightly extending state.

However, according to the strobe device of the exemplary embodiment, it is unnecessary for a user to perform an operation to form the strobe device into a shape which allows housing of the strobe device into the housing body. That is, when strobe device 2 is detached from imaging apparatus 1, a shape of strobe device 2 is automatically changed to a shape which conforms to the shape of the inner space of the housing body. As a result, the user can house strobe device 2 in the housing body as it is without operating strobe device 2. Next, the above-mentioned mounted-state angle of orientation will be described with reference to FIG. 5C and FIG. 5D.

As shown in FIG. 5C, in starting capturing, a user takes out strobe device 2 from the housing body, and mounts strobe device 2 on the hot shoe of imaging apparatus 1. At this time of operation, strobe device 2 is mounted in a state where strobe device 2 conforms to the shape of the inner space of the housing body, for example, in a state where strobe device 2 is extended straightly.

When strobe device 2 is mounted on imaging apparatus 1, control section 15 of strobe device 2 detects that strobe device 2 is mounted on imaging apparatus 1 by means of detection unit 26 configured of detection switch 26. Upon detection of mounting of strobe device 2 on imaging apparatus 1, control section 15 drives vertical-direction driving unit 20 and/or horizontal-direction driving unit 21.

Control section 15 varies the angle of orientation of light-emitting unit 10 in the vertical-direction and/or the angle of orientation of light-emitting unit 10 in the horizontal-direction. To be more specific, an angle formed by strobe body unit 9 and light-emitting unit 10 is automatically varied to the angle of orientation of strobe device 2 at the time of bounce photography, that is, a bent state or a state where light-emitting unit 10 is directed in the lens optical axis direction of imaging apparatus 1. With such an operation, the bounce photography can be performed without missing a perfect moment for the click of a shutter.

On the other hand, when the strobe device does not have a function of automatically correcting the mounted-state angle of orientation of light-emitting unit 10 of strobe device 2 as in the case of a conventional strobe device, it is necessary for a user to operate light-emitting unit 10 of strobe device 2 so as to bring light-emitting unit 10 into an angle suitable for bounce photography by holding and rotating light-emitting unit 10.

However, according to the strobe device of the exemplary embodiment, it is unnecessary for the user to perform the operation to bring light-emitting unit 10 of strobe device 2 into an angle for bounce photography. That is, when strobe device 2 is mounted on imaging apparatus 1, strobe device 2 is readily brought into a capturing start state. As a result, the user can perform capturing without missing a perfect moment for the click of a shutter.

The imaging apparatus and the strobe device of the present invention are not limited to the above-mentioned exemplary embodiment, and it is needless to say that various modifications may be added to the imaging apparatus and the strobe device of the present invention without departing from the gist of the present invention.

That is, in the above exemplary embodiment, the description has been made with respect to the example where the detached-state angle of orientation and the mounted-state angle of orientation shown in FIG. 5B and FIG. 5D are registered in storage unit 25 of control section 15 in advance. However, the present invention is not limited to such an example. That is, the detached-state angle of orientation in the exemplary embodiment is the angle of orientation of light-emitting unit 10 desired by a user after strobe device 2 is detached from imaging apparatus 1 and hence, any desired detached-state angle of orientation can be adopted. Further, the mounted-state angle of orientation in the exemplary embodiment is the angle of orientation of light-emitting unit 10 desired by a user in an initial state after strobe device 2 is mounted on imaging apparatus 1 and hence, any desired mounted-tate angle of orientation can be adopted.

As has been described heretofore, the strobe device according to the present invention includes: a strobe body unit which is detachably mounted on an imaging apparatus; a light-emitting unit rotatably coupled to the strobe body unit, a variable mechanism capable of varying an angle of orientation of the light-emitting unit with respect to the strobe body unit, a driving unit for driving the variable mechanism; a control section for controlling the driving unit; and a detection unit. The detection unit detects that the strobe body unit is detached from the imaging apparatus, and the control section has a mode of varying the angle of orientation of the light-emitting unit to a predetermined detached-state angle of orientation based on a detection result by the detection unit.

According to such a configuration, the control section controls the driving unit, and the driving unit drives the variable mechanism thus varying the angle of orientation of the light-emitting unit with respect to the strobe body unit. Further, when the strobe body unit of the strobe device is detached from the imaging apparatus, the control section recognizes the removal of the strobe body unit by detection unit. At this stage of operation, the control section controls the driving unit so as to bring the light-emitting unit of the strobe device into a predetermined detached-state angle of orientation. That is, when the strobe device is detached from the imaging apparatus, the angle of orientation of the light-emitting unit is automatically varied to the detached-state angle of orientation. Accordingly, it is possible to easily house the strobe device in a housing body in a state where the strobe device conforms to a shape of an inner space of the housing body. As a result, it is possible to realize the strobe device which has excellent operability by obviating an unnecessary operation by a user and prevents the occurrence of drawbacks at the time of housing the strobe device in the housing body.

According to the strobe device of the present invention, the predetermined detached-state angle of orientation may be the angle of orientation of the light-emitting unit which makes the strobe device ready to be housed in the housing body.

With such a configuration, when the strobe device is detached from the imaging apparatus, the angle of orientation of the light-emitting unit is varied automatically such that the light-emitting unit conforms to the shape of the inner space of the housing body. Accordingly, a user can easily house the strobe device in the housing body without correcting the angle of orientation of the light-emitting unit. As a result, the strobe device detached from the imaging apparatus can be directly and readily housed in the housing body.

Further, according to the strobe device of the present invention, the detection unit detects that the strobe body unit is mounted on the imaging apparatus, and the control section has a mode of varying the angle of orientation of the light-emitting unit to a predetermined mounted-state angle of orientation based on a detection result by the detection unit.

With such a configuration, when the strobe device is mounted on the imaging apparatus, the control section controls the driving unit such that the light-emitting unit takes the predetermined mounted-state angle of orientation. Accordingly, the angle of orientation of the light-emitting unit can be automatically varied to the predetermined mounted-state angle of orientation. As a result, when the strobe device is mounted on the imaging apparatus, it is possible to bring the strobe device into a state where the strobe device can be used directly and readily.

Further, according to the strobe device of the present invention, the predetermined mounted-state angle of orientation may be the angle of orientation of the light-emitting unit ready for picture-taking.

With such a configuration, when the strobe device is mounted on the imaging apparatus, even when a user does not correct the angle of orientation of the light-emitting unit to the capturing-start-time angle of orientation, the angle of orientation of the light-emitting unit is automatically varied to the capturing-start-time angle of orientation. Accordingly, it is possible to bring the strobe device mounted on the imaging apparatus into a usable state readily and directly. As a result, bounce photography or the like can be performed without missing a perfect moment for the click of a shutter.

Further, an imaging apparatus of the present invention may include the above-mentioned strobe device. Accordingly, it is possible to realize the imaging apparatus which has excellent operability and minimally generates drawbacks.

### INDUSTRIAL APPLICABILITY

The present invention is applicable to usages such as a strobe device and an imaging apparatus where it is desirable to obviate an unnecessary operation by a user after detaching the strobe device from the imaging apparatus or after mounting the strobe device on the imaging apparatus.

### REFERENCE MARKS IN THE DRAWINGS

1 imaging apparatus
2 strobe device
3 capturing function unit
4 control unit
5 display unit
6 operation unit
7 peripheral I/F
8 shutter
9 strobe body unit
9a top side
9b bottom side
9c front
9d back side
10 light-emitting unit
10a surface
11 flash discharge tube
12 variable mechanism
13 driving unit
14 angle detection unit
15 control section
16 operating unit
17 opening portion
18 vertical-direction variable mechanism
19 horizontal-direction variable mechanism
20 vertical-direction driving unit
21 horizontal-direction driving unit
22 vertical-direction angle detection unit
23 horizontal-direction angle detection unit
24 arithmetic operation unit
25 storage unit
26 detection switch (detection unit)
27 main capacitor

1. A strobe device comprising:
a strobe body unit detachably mounted on an imaging apparatus;
a light-emitting unit rotatably coupled to the strobe body unit;
a variable mechanism capable of varying an angle of orientation of the light-emitting unit with respect to the strobe body unit;
a driving unit for driving the variable mechanism;
a control section for controlling the driving unit; and
a detection unit,
wherein the detection unit detects that the strobe body unit is detached from the imaging apparatus, and
the control section has a mode of varying the angle of orientation of the light-emitting unit to a predetermined detached-state angle of orientation based on a detection result by the detection unit.

2. The strobe device according to claim 1, wherein the predetermined detached-state angle of orientation is an angle of orientation of the light-emitting unit which makes the strobe device ready to be housed in a housing body.

3. The strobe device according to claim 1, wherein the detection unit detects that the strobe body unit is mounted on the imaging apparatus, and the control section further has a mode of varying the angle of orientation of the light-emitting unit to a predetermined mounted-state angle of orientation based on a detection result by the detection unit.

4. The strobe device according to claim 3, wherein the predetermined mounted-state angle of orientation is an angle of orientation of the light-emitting unit ready for picture-taking.

5. An imaging apparatus which includes the strobe device according to claim 1.
